(19) United States
(12) Patent Application Publication
(10) Pub. No.: US 2025/0217828 A1
(43) Pub. Date: Jul. 3, 2025

(54) SYSTEMS AND METHODS FOR GENERATING DEMAND PREDICTION

(71) Applicant: Allstate Insurance Company, Northbrook, IL (US)

(72) Inventors: Marvin Lu, Chicago, IL (US); Raja Sekhar Thiruvathuru, Aurora, IL (US); Umamaheshwar R. Uppada, Palatine, IL (US); Peter Bouchard, Chicago, IL (US); Katherine Rose Swindler, Chicago, IL (US); Morgan Mosky, Chicago, IL (US); Reuel Neil Jose, Vernon Hills, IL (US)

(21) Appl. No.: 18/973,424

(22) Filed: Dec. 9, 2024

Related U.S. Application Data
(60) Provisional application No. 63/615,953, filed on Dec. 29, 2023.

(51) Int. Cl. G06Q 30/0202; G06Q 30/0204; G06Q 30/0251

(52) U.S. Cl. CPC G06Q 30/0202; G06Q 30/0204; G06Q 30/0269

(57) ABSTRACT

Implementations claimed and described herein provide systems and methods for predicting demand associated with a product or service. The systems and methods use a machine learning model to determine a potential consumer is likely to purchase a product or a service. A notification is generated based on the determination that the potential consumer is likely to purchase the product or the service.

### CROSS-REFERENCE TO RELATED APPLICATIONS

The present application claims priority to U.S. Provisional Patent Application No. 63/615,953 filed on Dec. 29, 2023, which is incorporated by reference in its entirety herein.

### FIELD

Aspects of the presently disclosed technology relate generally to computer interaction with a user.

### BACKGROUND

Consumers procure products and services through a variety of channels, ranging from online platforms to brick and mortar to authorized agents. Additionally, various advertising mechanisms are leveraged within each of these channels to reach target audiences. With such decentralization and disaggregation across disparate channels, ascertaining demand for a particular product or service is challenging, let alone how to increase demand by reaching target audiences. It is with these observations in mind, among others, that various aspects of the present disclosure were conceived and developed.

### SUMMARY

Implementations described and claimed herein address the foregoing problems by providing systems and methods for predicting demand related to products and services to determine an optimum time to initiate communication with a user. The systems and methods herein provide technical improvements to human-computer interaction (HCI), such as, for example, conventional computer-generated chatbots, by allowing for identification of potential consumers, how to persuade the potential consumers to purchase a product and/or service, and optimizing when to speak to the potential consumer about the product and/or service.

In some implementations, a computer implemented method can comprise: receiving data associated with a potential consumer of at least one of a product or a service, identifying a trigger event based on the data using a machine learning model, determining the potential consumer is likely to purchase at least one of the product or the service based on the trigger event using the machine learning model, generating a notification associated with at least one of the product or the service, and causing the notification to be presented using one or more output systems.

In some implementations, a system comprises a provider system in communication with a user device over a network, the user device having one or more input systems and one or more output systems, the provider system configured to receive data associated with a potential consumer of at least one of a product or a service, a demand prediction system having a machine learning model, the demand prediction system configured to identify an event based on the data using the machine learning model, the demand prediction system configured to predict the potential consumer is likely to purchase at least one of the product or the service based on the event using the machine learning model, and a notification generation system configured to generate a notification associated with at least one of the product or the service, the provider system configured to transmit the notification to the user device to cause the notification to be presented using the one or more output systems.

In some implementations, one or more tangible non-transitory computer-readable storage media store computer-executable instructions for performing a computer process on a computing system, the computer process comprising: receiving data associated with a potential consumer, identifying an event based on the data using a machine learning model, predicting the potential consumer is likely to purchase a product or a service based on the event using the machine learning model, generating a notification associated with the product or the service, and causing the notification to be presented using one or more output systems of a user device.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates an example communication system.

FIG. 2 illustrates an example provider system.

FIG. 3 illustrates an example computing system that may implement various aspects of the communication system.

FIG. 4 illustrates example operations for communicating a notification.

### DETAILED DESCRIPTION

Aspects of the present disclosure involve systems and methods to determine an optimum time to contact a user. For instance, demand regarding a product or service is predicted. The systems and methods described herein use a machine learning model to provide a robust demand prediction before a notification (e.g., an advertisement, product information, etc.) is sent to a potential consumer. The machine learning model is trained using historical data relating to products and services purchased by consumers. This results in a more efficient platform that predicts moments of receptivity to begin showing a potential consumer communication to consider a product or service to drive successful sales of the product or service. Additional advantages of the presently disclosed technology will become apparent from the detailed description below.

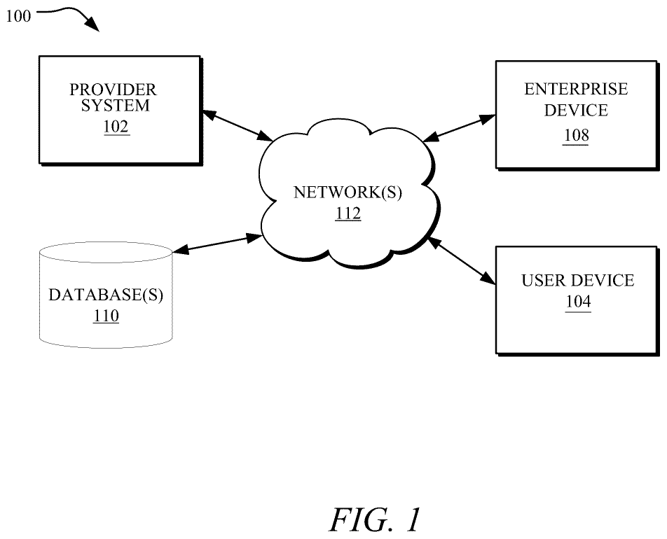

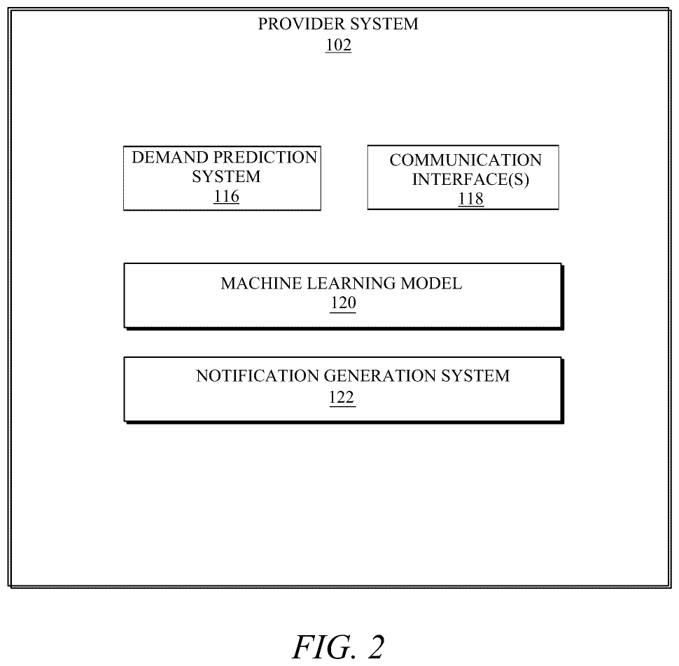

To begin a detailed description of an example communication system 100 for predicting demand for a product and/or service and generating a notification based on the demand, reference is made to FIGS. 1-4. The system 100 can include a provider system 102 configured to receive data regarding a potential consumer of a product and/or service. For instance, the data can include past purchase behavior, registration for product information, engagement data (e.g., request for product info, subscription to product information, etc.). The data can be inputted by the potential consumer via one or more input systems using, for example, a user device 104 to input text, audio, and/or interact with an interactive user interface displayed on one or more output systems of, for example, the user device 104. For instance, the data can be input using a chatbot, pricing tool, web form, etc. In an implementation, the data is received from at least one of an enterprise device 108 and/or one or more databases 110. Upon receiving the user data, the provider system 102 processes the data using a demand prediction system 116 to determine if the potential consumer is likely to purchase. The provider system 102, the enterprise device 108, and the one or more databases 110 are configured to interact with one another via a network(s) 112. As illustrated in greater detail below, any and/or all of the provider system 102, the demand prediction system 116, a notification generation system 122, the enterprise device 108, the user device 104, the one or more databases 110 may, in some instances, be special-purpose computing devices configured to perform specific functions.

The provider system 102 includes one or more computing devices (e.g., servers, routers, user interface devices, internet telephony computing device, and the like) that store and/or retrieve data in the one or more databases 110, provide user interfaces, phone system functionality, execute the demand prediction system 116, the notification generation system 122, etc. by processing instructions. The provider system 102 may include a communication interface(s) 118 that is able to communicate with the one or more input systems and one or more output systems via the network(s) 112. For instance, the communication interface(s) 118 may be a network interface configured to support communication between the provider system 102 and the network(s) 112. The one or more input systems and one or more output systems may be part of the user device 104 or separate from the user device 104. The provider system 102 can be configured to train and maintain the machine learning model 120 to execute the techniques, as discussed in greater detail below. The provider system 102 can be configured to monitor and store (e.g., with appropriate permissions) communication from a potential consumer for further analysis and/or training of a machine learning model 120. In an implementation, the provider system 102 is configured to transmit the communication to another computing device or database, such as the one or more databases 110. In an implementation, the provider system 102 is associated with an organization or entity. In an implementation, the provider system 102 can retrieve and send policy and/or benefit information that indicates what product or services are currently used by the potential consumer.

In an implementation, the user device 104 includes one or more input systems and one or more output systems. For instance, the potential consumer is able to input data to the provider system 102 via one or more interactive user interfaces using the user device 104. The user device 104 can be a computing device (e.g., smartphone, tablet, desktop computer, laptop computer, or other personal computing device) that may be used by an individual (e.g., a customer of an enterprise organization, such as an insurance provider). In some instances, the user device 104 may be used to display notifications and/or other alerts/graphical user interfaces.

In an implementation, the machine learning model 120 is trained to predict a potential customer demand related to products and/or services. The machine learning model 120 can include a linear regression model, an unsupervised neural network model, gradient boosted trees, etc. The machine learning model 120 may be built from historical user data associated with purchasing product and/or services stored, for example, at the one or more databases 110. In this implementation, the machine learning model 120 leverages historical user data relating to user data associated with one or more consumers purchasing a product and/or a service. In an implementation, weights are applied to the variables based on importance. For instance, the training set can include historical user data that resulted in a successful sale of a product or service. Depending on the model type, a holdout data set would be used to train the model and then score the non-holdout data set. Example historical user data includes at least one of a life event (e.g., change in marital status, birth of a child, death, buying an asset, moving, graduating, etc.), brand loyalty, buying habits, internet search habits, digital behaviors, life-time value, age, race, ethnicity, gender, income level, education level, employment status, occupation, homeownership, zip code, location, number of accidents, number of insurance claims, age of home, value of home, age of car, value of car, location density, years of being a customer, profitability, credit score, etc. In an implementation, the historical user data is obtained from website visits, search engine entries, a quote start for products/services, a quote completion for products/services, survey queries, social media interactions, application downloads/interactions, telematics use, advertisement exposure, etc.

In an implementation, the machine learning model 120 allows the demand prediction system 116 to identify a trigger event for the user based on data associated with the potential consumer and the historical user data. The data can be received from one or more of the one or more databases 110 and inputs from the potential consumer via one or more input systems of the user device 104. The data includes at least one of a life event (e.g., change in marital status, birth of a child, death, buying an asset, moving, graduating, etc.), brand loyalty, buying habits, internet search habits, digital behaviors, life-time value, age, race, ethnicity, gender, income level, education level, employment status, occupation, homeownership, zip code, location, number of accidents, number of insurance claims, age of home, value of home, age of car, value of car, location density, years of being a customer, profitability, credit score, etc. of the potential consumer. In an implementation, the data is obtained from website visits, search engine entries, a quote start for products/services, a quote completion for products/services, survey queries, social media interactions, etc. For instance, the data can be processed using sentiment analysis to determine if the user is ready to purchase a product. Based on the trigger event, the machine learning model 120 allows the demand prediction system 116 to determine a potential consumer is likely to purchase a product or a service. Accordingly, the machine learning model 120 allows the demand prediction system 116 to determine the ideal time to communicate information about the product or the service to the potential consumer by predicting consumer life events, behaviors and/or attitudes that precede a product and/or service search, thereby mapping consumer content consumption to key moments and/or paths to aid a provider to maximize brand reach and message effectiveness.

In an implementation, the notification generation system 122 is configured to perform one or more of the functions described herein. For example, the notification generation system 122 may have instructions that direct and/or cause the notification generation system 122 to generate a notification regarding the product or the service. For instance, the notification is an advertisement, a recommendation for a suggested product or service, a promotion of a product or service, etc. In an implementation, the notification is tailored specifically for the potential consumer based on the data, such as, known variables of the potential consumer and what the importance of the variables to the model. For instance, the notification may include a name of the potential consumer, an identification of a property of the potential consumer, a quote for the product or the service, etc. The notification can be output using text, audio, and/or visual representations, such as, for example, maps, graphs, animations, etc. Based on an analysis of the known variables of the potential consumer, the notification generation system 122 determines which output to utilize. In an implementation, the notification is presented via one or more interactive user interfaces generated by the notification generation system 122 and transmitted, via the communication interface(s) 118, to the user device 104 for display by the output system of the user device 104. In an implementation, the one or more interactive user interfaces are generated using Generative Artificial Intelligence. In another implementation, the one or more interactive user interfaces are generated using a personalization engine.

The provider system 102 may have instructions that direct and/or cause the provider system 102 to receive data associated with a potential consumer of a product or a service, identify a trigger event based on the data service using the machine learning model 120, determine the potential consumer is likely to purchase the product or service based on the trigger event using the machine learning model 120, generate a notification associated with the product or the service, transmit the notification to the user device 104 to cause an output of the notification via the user device 104, receive product and/or service selections associated with the product and/or service that the potential consumer wishes to purchase, and provide the product and/or service to the potential consumer.

In an implementation, the enterprise device 108 is able to communicate with the user device 104 via the network(s) 112, such as though a phone call, chat session, e-mail, etc. The enterprise device 108 can be a computing device (e.g., smartphone, tablet, desktop computer, laptop computer, or other personal computing device) that may be used by an individual (e.g., an employee of an enterprise organization, such as a customer service representative, salesperson, agent, etc. for an insurance or financial services provider). In an implementation, the notification generated using the machine learning model 120 is transmitted to the enterprise device 108 to prompt the enterprise device 108 to communicate the notification to the user device 104.

The network(s) 112 can be any combination of one or more of a cellular network such as a 3rd Generation Partnership Project (3GPP) network, a third generation (3G) network, a fourth generation (4G) network, a fifth generation (5G) network, a Long-Term Evolution (LTE), an LTE Advanced Network, a Global System for Mobile Communications (GSM) network, a Universal Mobile Telecommunications System (UMTS) network, and the like. Moreover, the network(s) 112 can include any type of network, such as the Internet, an intranet, a Virtual Private Network (VPN), a Voice over Internet Protocol (VOIP) network, a wireless network (e.g., Bluetooth), a cellular network, a satellite network, combinations thereof, etc. The network(s) 112 can include communications network components such as, but not limited to gateways routers, servers, and registrars, which enable communication across the network(s) 112. In one implementation, the communications network components include multiple ingress/egress routers, which may have one or more ports, in communication with the network(s) 112.

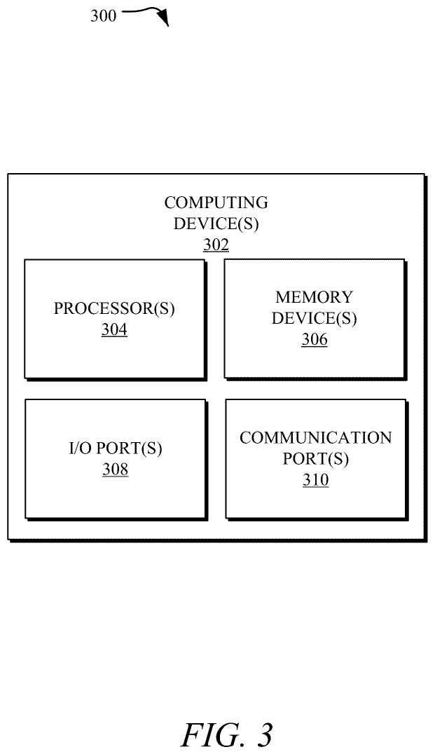

Turning to FIG. 3, a system 300 to process a request can include one or more computing devices 302 for performing the techniques discussed herein. In one implementation, the one or more computing devices 302 include the user device 104, one or more servers of the provider system 102, and/or the enterprise device 108 to generate and execute the demand prediction system 116, notification generation system 122, etc. as a software application and/or a module or algorithmic component of software.

In some instances, the computing device 302 can include a computer, a personal computer, a desktop computer, a laptop computer, a terminal, a workstation, a server device, a cellular or mobile phone, a mobile device, a smart mobile device a tablet, a wearable device (e.g., a smart watch, smart glasses, a smart epidermal device, etc.) a multimedia console, a television, an Internet-of-Things (IoT) device, a smart home device, a medical device, a virtual reality (VR) or augmented reality (AR) device, a vehicle (e.g., a smart bicycle, an automobile computer, etc.), and/or the like. The computing device 302 may be integrated with, form a part of, or otherwise be associated with the systems 100-300. It will be appreciated that specific implementations of these devices may be of differing possible specific computing architectures not all of which are specifically discussed herein but will be understood by those of ordinary skill in the art.

The computing device 302 may be a computing system capable of executing a computer program product to execute a computer process. Data and program files may be input to the computing device 302, which reads the files and executes the programs therein. Some of the elements of the computing device 302 include one or more processors 304, one or more memory devices 306, and/or one or more ports, such as input/output (IO) port(s) 308 and communication port(s) 310. Additionally, other elements that will be recognized by those skilled in the art may be included in the computing device 302 but are not explicitly depicted in FIG. 3 or discussed further herein. Various elements of the computing device 302 may communicate with one another by way of the communication port(s) 310 and/or one or more communication buses, point-to-point communication paths, or other communication means.

The processor 304 may include, for example, a central processing unit (CPU), a microprocessor, a microcontroller, a digital signal processor (DSP), and/or one or more internal levels of cache. There may be one or more processors 304, such that the processor 304 comprises a single central-processing unit, or a plurality of processing units capable of executing instructions and performing operations in parallel with each other, commonly referred to as a parallel processing environment.

The computing device 302 may be a conventional computer, a distributed computer, or any other type of computer, such as one or more external computers made available via a cloud computing architecture. The presently described technology is optionally implemented in software stored on the data storage device(s) such as the memory device(s) 306, and/or communicated via one or more of the I/O port(s) 308 and the communication port(s) 310, thereby transforming the computing device 302 in FIG. 3 to a special purpose machine for implementing the operations described herein. Moreover, the computing device 302, as implemented in the systems 100-300, receives various types of input data (e.g., the text communication) and transforms the input data through various stages of the data flow into new types of data files (e.g., identify a trigger event and determining a potential consumer is likely to purchase a product or a service in response to receiving data associated with the potential consumer). Moreover, these new data files are transformed further into a notification relating to the product or the service and sent to the user device 104 to provide information regarding the product and/or service to the potential consumer, which enables the computing device 302 to do something it could not do before-determine a potential consumer is likely to begin searching for a product and/or service using a machine learning model trained using historical user data.

Additionally, the systems and operations disclosed herein represent an improvement to the technical field of human-computer interaction (HCI), machine learning, and natural language processing. For instance, the provider system 102 can generate a notification regarding a product or service in response to identification of a trigger event and automatically determining a potential consumer is likely to purchase the product or the service without human intervention. Moreover, data can be leveraged from different data sources with varying levels of abstraction to provide a highly efficient and effective notifications regarding products and/or services. These techniques are rooted in technology and could not have existed prior to the advent of machine learning analytics and natural language processing.

The one or more memory device(s) 306 may include any non-volatile data storage device capable of storing data generated or employed within the computing device 302, such as computer executable instructions for performing a computer process, which may include instructions of both application programs and an operating system (OS) that manages the various components of the computing device 302. The memory device(s) 306 may include, without limitation, magnetic disk drives, optical disk drives, solid state drives (SSDs), flash drives, and the like. The memory device(s) 306 may include removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory device(s) 306 may include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the memory device(s) 306 which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures.

In some implementations, the computing device 302 includes one or more ports, such as the I/O port(s) 308 and the communication port(s) 310, for communicating with other computing, network, or vehicle computing devices. It will be appreciated that the I/O port 308 and the communication port 310 may be combined or separate and that more or fewer ports may be included in the computing device 302.

The I/O port 308 may be connected to an I/O device, or other device, by which information is input to or output from the computing device 302. Such I/O devices may include, without limitation, one or more input devices, output devices, and/or environment transducer devices.

In one implementation, the input devices convert a human-generated signal, such as, human voice, physical movement, physical touch or pressure, and/or the like, into electrical signals as input data into the computing device 302 via the I/O port 308. Similarly, the output devices may convert electrical signals received from the computing device 302 via the I/O port 308 into signals that may be sensed as output by a human, such as sound, light, and/or touch. The input device may be an alphanumeric input device, including alphanumeric and other keys for communicating information and/or command selections to the processor 304 via the I/O port 308. The input device may be another type of user input device including, but not limited to direction and selection control devices, such as a mouse, a trackball, cursor direction keys, a joystick, and/or a wheel; one or more sensors, such as a camera, a microphone, a positional sensor, an orientation sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

The environment transducer devices convert one form of energy or signal into another for input into or output from the computing device 302 via the I/O port 308. For example, an electrical signal generated within the computing device 302 may be converted to another type of signal, and/or vice-versa. In one implementation, the environment transducer devices sense characteristics or aspects of an environment local to or remote from the computing device 302, such as, light, sound, temperature, pressure, magnetic field, electric field, chemical properties, physical movement, orientation, acceleration, gravity, and/or the like.

In one implementation, the communication port 310 is connected to the network(s) 112 so the computing device 302 can receive network data useful in executing the methods and systems set out herein as well as transmitting information and network configuration changes determined thereby. Stated differently, the communication port 310 connects the computing device 302 to one or more communication interface devices configured to transmit and/or receive information between the computing device 302 and other devices by way of one or more wired or wireless communication networks or connections. Examples of such networks or connections include, without limitation, Universal Serial Bus (USB), Ethernet, Wi-Fi, Bluetooth®, Near Field Communication (NFC), and so on. One or more such communication interface devices may be utilized via the communication port 310 to communicate with one or more other machines, either directly over a point-to-point communication path, over a wide area network (WAN) (e.g., the Internet), over a local area network (LAN), over a cellular network (e.g., third generation (3G), fourth generation (4G), Long-Term Evolution (LTE), fifth generation (5G), etc.) or over another communication means. Further, the communication port 310 may communicate with an antenna or other link for electromagnetic signal transmission and/or reception.

In an example, the demand prediction system 116, the notification generation system 122, etc., and/or other software, modules, services, and operations discussed herein may be embodied by instructions stored on the memory device(s) 306 and executed by the processor 304.

The system set forth in FIG. 3 is but one possible example of a computing device 302 or computer system that may be configured in accordance with aspects of the present disclosure. It will be appreciated that other non-transitory tangible computer-readable storage media storing computer-executable instructions for implementing the presently disclosed technology on a computing system may be utilized. In the present disclosure, the methods disclosed may be implemented as sets of instructions or software readable by the computing device 302.

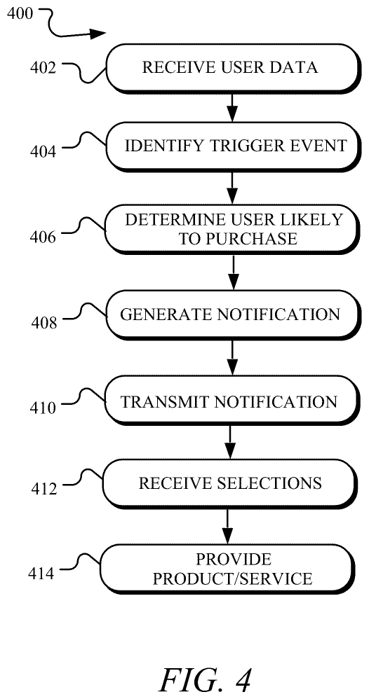

FIG. 4 depicts an example method 400 to predict demand regarding a product or service, which can be performed by any of the systems 100-300 discussed herein. The method 400 can, in some instances, occur in real time.

At operation 402, the method 400 can receive data associated with a potential consumer of the product or the service via a user device 104, an enterprise device 108, and/or database(s) 110. In an implementation, the data is inputted by a user via one or more input systems of the user device 104.

At operation 404, the method 400 can identify a trigger event based on the data using the machine learning model 120.

At operation 406, the method 400 can determine the potential consumer is likely to purchase the product or the service based on the trigger event using the machine learning model 120.

At operation 408, the method 400 can generate a notification associated with the product or the service based on the determining the potential consumer is likely to purchase the product using the notification generation system 122. In an implementation, the notification includes at least one of an interactive user interface having one or more of a plurality of selectable products and/or services, a recommended additional product and/or additional service, an explanation of the product and/or service, or a comparison with products and/or services used by users with similar characteristics as the potential consumer.

At operation 410, the method 400 can transmit the notification to one or more output systems of, for example, the user device 104 and/or the enterprise device 108 via the network(s) 112. The user device 104 and/or enterprise device 108 can visually and/or audibly outputs the notification.

At operation 412, the method 400 can receive a selection indicating the service and/or product the potential consumer desires to purchase. In an implementation, the selection is selected by the potential consumer via one or more input systems, such as, for example, an interactive user interface displayed on the user device 104.

At operation 414, the method 400 can provide the service and/or product to the potential consumer. For instance, the method 400 subscribes the user to the service and/or product offered by the provider, such as a policy from a company.

It is to be understood that the specific order or hierarchy of operations in the methods depicted in FIG. 4 and throughout this disclosure are instances of example approaches and can be rearranged while remaining within the disclosed subject matter. For instance, any of the operations depicted in FIG. 4 may be omitted, repeated, performed in parallel, performed in a different order, and/or combined with any other of the operations depicted in FIG. 4 or discussed herein.

Furthermore, any term of degree such as, but not limited to, “substantially,” as used in the description and the appended claims, should be understood to include an exact, or a similar, but not exact configuration. Similarly, the terms “about” or “approximately,” as used in the description and the appended claims, should be understood to include the recited values or a value that is three times greater or one third of the recited values. For example, about 3 mm includes all values from 1 mm to 9 mm, and approximately 50 degrees includes all values from 16.6 degrees to 150 degrees.

Lastly, the terms “or” and “and/or,” as used herein, are to be interpreted as inclusive or meaning any one or any combination. Therefore, “A, B, or C” or “A, B, and/or C” mean any of the following: “A,” “B,” or “C”; “A and B”; “A and C”; “B and C”; “A, B and C.” An exception to this definition will occur only when a combination of elements, functions, steps or acts are in some way inherently mutually exclusive.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined differently in various implementations of the disclosure or described with different terminology. These and other variations, modifications, additions, and improvements may fall within the scope of the disclosure as defined in the claims that follow.

What is claimed is:

1. A system comprising:
a provider system in communication with a user device over a network, the user device having one or more input systems and one or more output systems, the provider system configured to receive data associated with a potential consumer of at least one of a product or a service;
a demand prediction system having a machine learning model, the demand prediction system configured to identify an event based on the data using the machine learning model, the demand prediction system configured to predict the potential consumer is likely to purchase at least one of the product or the service based on the event using the machine learning model; and
a notification generation system configured to generate a notification associated with at least one of the product or the service, the provider system configured to transmit the notification to the user device to cause the notification to be presented using the one or more output systems.

2. The system of claim 1, wherein the provider system is configured to receive a selection via the one or more input systems through interaction by the potential consumer with the user device, the selection indicating at least one of the product or the service the potential consumer desires to purchase.

3. The system of claim 1, wherein the data includes at least one of a life event, brand loyalty, a buying habit, an internet search habit, digital behavior, a life-time value, age, race, ethnicity, gender, income level, education level, employment status, occupation, homeownership, zip code, location, number of accidents, number of insurance claims, age of home, value of home, age of car, value of car, location density, years of being a customer, profitability, or a credit score.

4. The system of claim 1, wherein the notification includes at least one of a plurality of selectable products or services, a recommended additional product or additional service, an explanation of at least one of the product or the service, or a comparison with users with similar characteristics as the potential consumer.

5. The system of claim 1, wherein the notification is at least one of an advertisement for the product or the service, a recommendation for the product or the service, or a promotion of at least one of the product or the service.

6. The system of claim 1, wherein the machine learning model is trained using historical user data relating to one or more consumers purchasing the product or the service.

7. A computer implemented method comprising:
receiving data associated with a potential consumer of at least one of a product or a service;
identifying a trigger event based on the data using a machine learning model;
determining the potential consumer is likely to purchase at least one of the product or the service based on the trigger event using the machine learning model;
generating a notification associated with at least one of the product or the service; and
causing the notification to be presented using one or more output systems.

8. The computer implemented method of claim 7 further comprising:
receiving a selection via one or more input systems through interaction by the potential consumer, the selection indicating at least one of the product or the service the potential consumer desires to purchase.

9. The computer implemented method of claim 8 further comprising:
providing at least one of the product or the service to the potential consumer based on the selection.

10. The computer implemented method of claim 7, wherein the data includes at least one of a life event, brand loyalty, a buying habit, an internet search habit, digital behavior, a life-time value, age, race, ethnicity, gender, income level, education level, employment status, occupation, homeownership, zip code, location, number of accidents, number of insurance claims, age of home, value of home, age of car, value of car, location density, years of being a customer, profitability, or a credit score.

11. The computer implemented method of claim 7, wherein the notification includes at least one of a plurality of selectable products or services, a recommended additional product or additional service, an explanation of at least one of the product or the service, or a comparison with users with similar characteristics as the potential consumer.

12. The computer implemented method of claim 7, wherein the notification is at least one of an advertisement for at least one of the product or the service, a recommendation for at least one of the product or the service, or a promotion of at least one of the product or the service.

13. The computer implemented method of claim 7, wherein the machine learning model is trained using historical user data relating to one or more consumers purchasing at least one of the product or the service.

14. The computer implemented method of claim 7, wherein the one or more output systems are integrated into a user device.

15. One or more tangible non-transitory computer-readable storage media storing computer-executable instructions for performing a computer process on a computing system, the computer process comprising:
receiving data associated with a potential consumer;
identifying an event based on the data using a machine learning model;
predicting the potential consumer is likely to purchase a product or a service based on the event using the machine learning model;
generating a notification associated with the product or the service; and
causing the notification to be presented using one or more output systems of a user device.

16. The one or more tangible non-transitory computer-readable storage media storing computer-executable instructions for performing the computer process on the computing system of claim 15, the computer process comprising:
receiving a selection via one or more input systems through interaction by the potential consumer, the selection indicating at least one of the product or the service the potential consumer desires to purchase.

17. The one or more tangible non-transitory computer-readable storage media storing computer-executable instructions for performing the computer process on the computing system of claim 16, the computer process comprising:
providing at least one of the product or the service to the potential consumer based on the selection.

18. The one or more tangible non-transitory computer-readable storage media storing computer-executable instructions for performing the computer process on the computing system of claim 15, wherein the data includes at least one of a life event, brand loyalty, a buying habit, an internet search habit, digital behavior, a life-time value, age, race, ethnicity, gender, income level, education level, employment status, occupation, homeownership, zip code, location, number of accidents, number of insurance claims, age of home, value of home, age of car, value of car, location density, years of being a customer, profitability, or a credit score.

19. The one or more tangible non-transitory computer-readable storage media storing computer-executable instructions for performing the computer process on the computing system of claim 15, wherein the notification includes at least one of a plurality of selectable products or services, a recommended additional product or service, an explanation of at least one of the product or the service, or a comparison with users with similar characteristics as the potential consumer.

20. The one or more tangible non-transitory computer-readable storage media storing computer-executable instructions for performing the computer process on the computing system of claim 15, wherein the notification is at least one of an advertisement for at least one of the product or the service, a recommendation for at least one of the product or the service, or a promotion of at least one of the product or the service.
